(19) United States
(12) Patent Application Publication
(10) Pub. No.: US 2002/0097411 A1
(43) Pub. Date: Jul. 25, 2002

(54) Facility and method for exchanging image data with controlled quality and / or size

(76) Inventors: Stephane Roche, Le Cannet (FR); Patrick Haddad, Antibes (FR); Olivier Lau, Cagnes Sur Mer (FR)

Correspondence Address: BIRCH, STEWART, KOLASCH & BIRCH, LLP, INTELLECTUAL PROPERTY LAW, SUITE 500 EAST, 8110 GATEHOUSE ROAD, FALLS CHURCH, VA, 22042-1210, US

(21) Appl. No.: 09/772,912

(22) Filed: Jan. 31, 2001

(30) Foreign Application Priority Data
Nov. 28, 2000 (FR) 0015367

(51) Int. Cl. B41B 1/00; G06F 15/00

(52) U.S. Cl. 358/1.9; 358/1.2

(57) ABSTRACT

A facility providing image data exchange between client terminals (1) and at least a service terminal (2), via a communications networks. Each client terminal (1) includes data display means (5) and first processing means, configured for placing in a request for accessing an image, intended for the server terminal (2), display characteristics of the client terminal. The server terminal (2) includes a second processing means capable i) of extracting from an request for accessing an image, received from a client terminal, the characteristics of its display means, ii) of establishing a correspondence between the different data types of the image and the display characteristics, and iii) of determining from the display characteristics corresponding to the data types of the image, those which are the closest to the extracted display characteristics so that the image data associated with the type of data corresponding to the determined characteristics are transmitted to the client terminal.

The invention relates to the fields of compression, storage, transmission, decompression and display of images, and more specifically to facilities and methods providing exchange of compressed image data between a service terminal and client terminals, via a communications network.

In certain known facilities, compression of raw data from an image includes a step for breaking it down into resolution levels implementing a so-called “wavelet” technique, followed by a step for breaking it down into layers of quality. Raw data which define an image generally relate to several types of information, and notably to resolution, quality, number of colors, etc.

The wavelet technique is particularly suitable for transmitting images because of the high compression rates that it provides, typically from 5 to 15 for a grey scale image and from 10 to 100 for a color image. However, because, of bandwidth limitations in communications networks, these compression rates are insufficient, as the tine required for transmitting an image, oven compressed, may become incompatible with the user's requirements. This is notably the case in the field of data transmission between portable terminals such as portable telephones, personal digital assistants or portable microcomputers. This drawback is even reinforced in the case of the public Internet network, because of the very high occupation rate of the bandwidth.

Accordingly, the object of the invention is to provide an original solution to the problem discussed above.

For this purpose, it provides a facility for exchanging compressed image data of the type discussed above and wherein:

each client terminal includes data display means and first processing means, configured for placing in a request for accessing an image, intended for the server terminal, at least certain of the display characteristics of the display means (for example, the format of a data display area as well as optionally, the number of encoding bits for the display pixels), and

the server terminal includes second processing means configured for i) extracting from a request for accessing an image, received from a client terminal, the characteristics of its display means (for example, resolution and/or the number of colors), ii) establishing a correspondence between at least one of the data types of the image and one of the display characteristics, and iii) determining, according to a selective criterion, from the display characteristics corresponding to different data types (resolution, quality, number of colors, etc.) of the image, those which are the closest to (or compatible with) the extracted display characteristics, so that the image data associated with the data type(s) of the image corresponding to the determined characteristics are transmitted to the client terminal.

As the image is adapted to the display means of the client terminal, the time required for its transmission is therefore notably reduced.

Here, the data types of an image are related both to the quality layers and resolution levels.

According to another characteristic of the invention, the quality levels are advantageously complementary to each other. In this case, the second processing means are able to transmit to the client terminal requesting access to an image, not only the image data associated with at least a portion of the highest quality layer, which corresponds to the data type (s) compatible with the display characteristics, but also the image data associated with at least a portion of the layers with a lower quality than the determined one. These data may be sent only once or else in successive portions depending on the performances of the network and of the client terminal. In the latter situation, the data are sent in an ascending order of quality, in such a way that the image's quality is gradually enhanced.

The facility according to the invention may also include at least one of the characteristics mentioned hereafter, either taken separately or combined:

second processing means capable of sending to the first processing means of a client terminal requesting both the determined image data and the format (resolution and/or number of encoding bits and/or number of colors) of this image's data which correspond to the quality layers, from the least highest to the highest (except for a counter-indication contained in the client's request);

first processing means capable of placing in an access request, information referring to an image area so that the second processing means transmit the image data associated with this area. In this case, the second processing means are advantageously capable i) of extracting from the access request the area information in order to determine the associated display characteristics, ii) of determining from the display characteristics which correspond to the different data types of the image (preferably from the different resolution levels) those which are the closest to the display characteristics associated with the area, in order to transmit to the client terminal the image data associated with at least a portion of the different quality layers (in fact, the portion corresponding to the highest determined resolution level if the latter has not already been transmitted). Furthermore it is advantageous that, consecutively to receiving the first and second requests for accessing an image, each including first and second pieces of area information, the second processing means are able i) to compare the first and second pieces of area information in order to search for possible non-overlapping areas, and ii) to transmit to the first processing means, the image data associated with this non-overlapping area and with at least a portion of the different quality layers (in fact, the portion corresponding to the highest determined resolution level if the latter has not already been transmitted);

first processing means capable of placing in an access request, information referring to a resolution level. In this case, the second processing means are advantageously capable i) of extracting from the different quality layers, the data associated with the required resolution level in order to determine the image's associated display characteristics, ii) of comparing these characteristics associated with the display characteristics of the client terminal, iii) then of transmitting the whole or part of the data associated with the required resolution level according to whether the associated characteristics are compatible with the characteristics of the client terminal;

second processing means capable of supplementing image data with information referring to their quality layer(s), so that the first image means rebuild the required image from the data received in answer to the successive access requests;

a data base for storing the image files which have been broken down.

The invention is also related to an image data transmission device including second image processing means of the type of those discussed above, and to an image data receiving device including first image processing means of the type of those discussed above.

The invention also provides a method for implementing the facility and devices shown above. This method is notably characterized by the fact that it comprises at least:

a first step for generating a request for accessing an image, including the display characteristics of the display means of the requesting client terminal, and

a second step wherein i) the characteristics of the display means are extracted from the access request, ii) a correspondence is established between the different types of image data and the display characteristics, and iii) from the display characteristics corresponding to the different types of image data, those which are the closest to the extracted display characteristics are determined, so that the image data associated with the type(s) of data corresponding to the determined characteristics are transmitted to the client terminal.

The invention is particularly suitable for public communications networks, as for example the Internet and also private networks, as for example those of the Intranet type, and to which are connected client terminals, notably of the portable telephone, personal digital assistant (PDA), or portable microcomputer type.

Other characteristics and advantages of the invention will become apparent upon examining the detailed descriptions hereafter and the appended drawings, wherein:

FIG. 1 schematically illustrates a facility according to the invention,

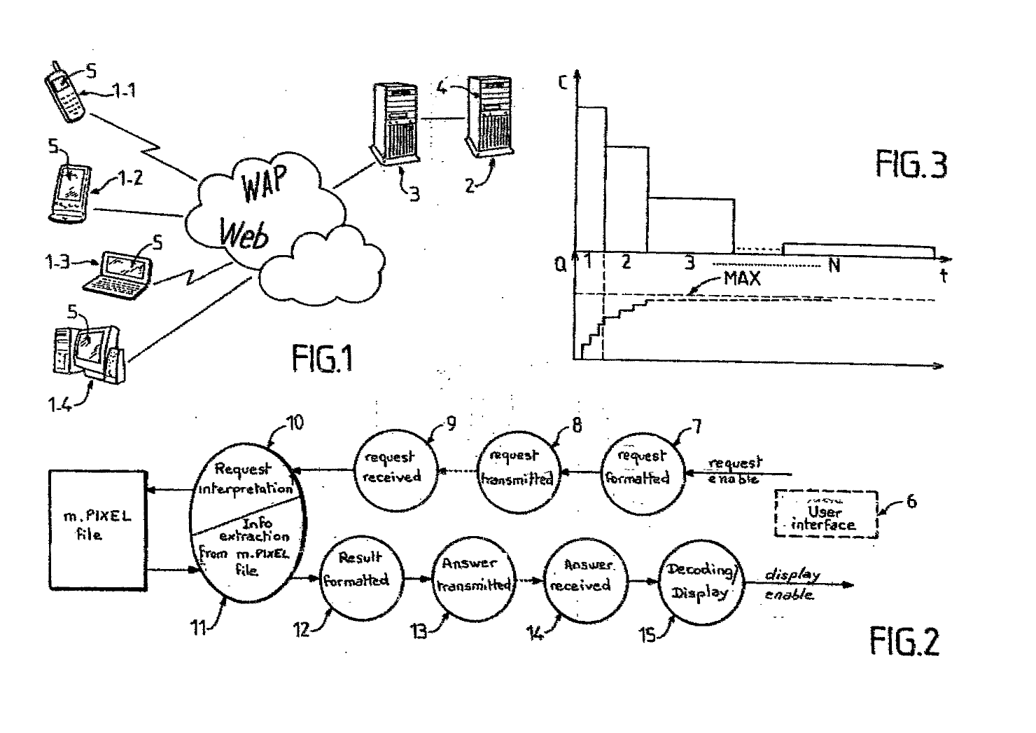

FIG. 2 schematically illustrates a line of data exchange in a facility according to the invention,

FIG. 3 is a graph illustrating the contribution (C) of image data to visual quality and image quality (Q) versus time (t),

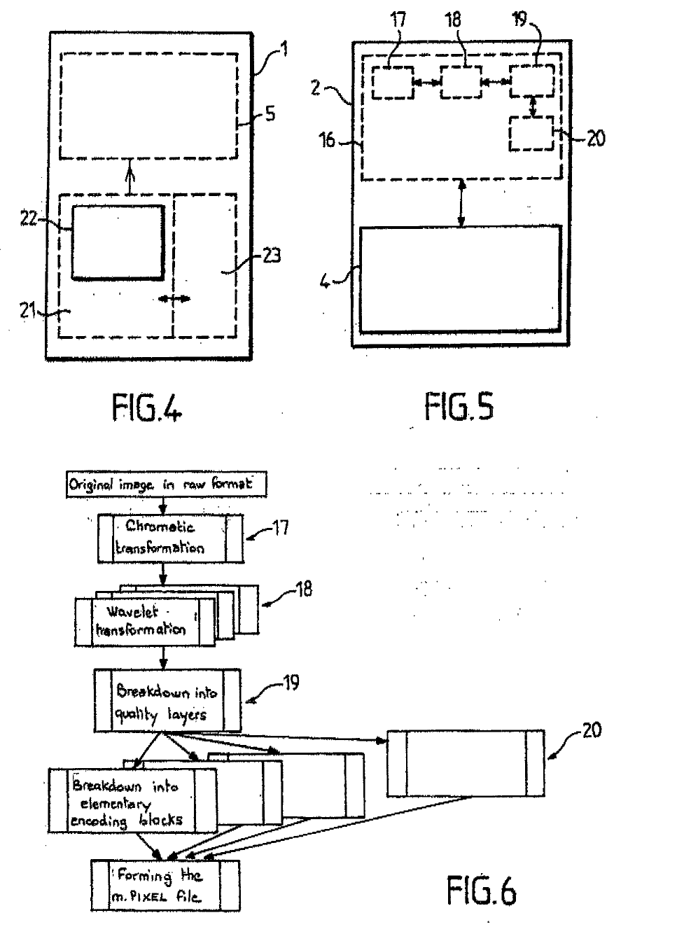

FIG. 4 is a block diagram schematically illustrating a device for transmitting image data implemented in a server terminal of the facility,

FIG. 5 is a block diagram schematically illustrating a device for receiving image data implemented in a client terminal of the facility of FIG. 1,

FIG. 6 schematically illustrates the main steps for generating a broken down and compressed file,

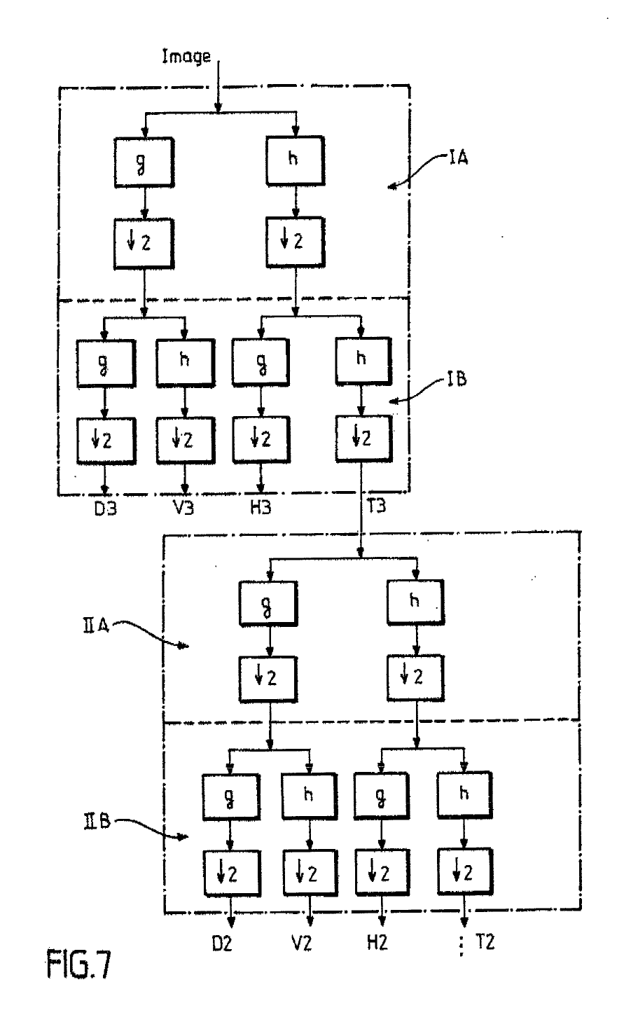

FIG. 7 schematically illustrates two consecutive steps for breaking down the data by means of the wavelet technique,

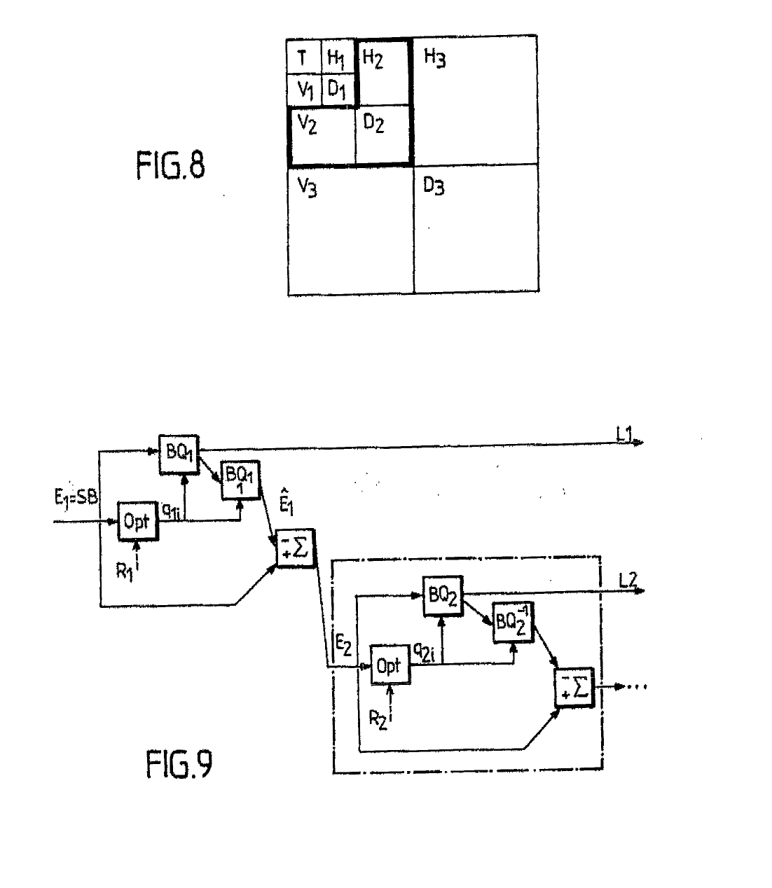

FIG. 8 schematically illustrates a multi-resolution configuration resulting from a breakdown into wavelets,

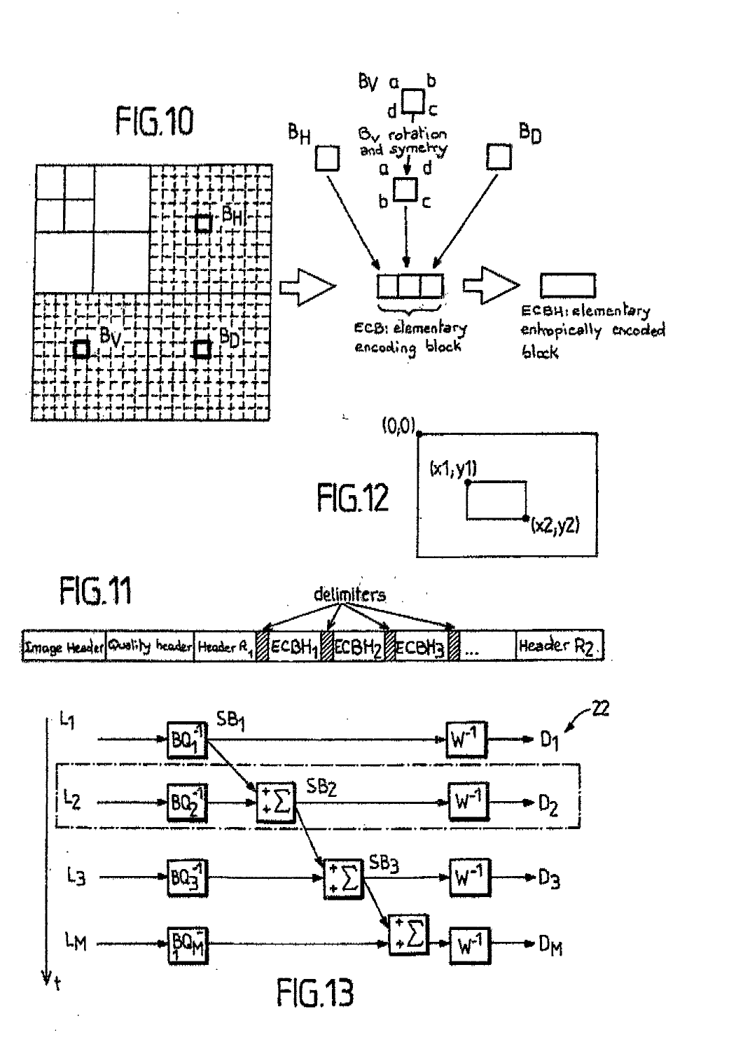

FIG. 9 is a functional diagram illustrating the breakdown into complementary quality layers,

FIG. 10 schematically illustrates (for the highest resolution sub-bands) a tiling of the set of sub-bands of a quality layer, thus defining the elementary blocks to be encoded,

FIG. 11 schematically illustrates an example of a broken down and compressed file structure according to the invention,

FIG. 12 schematically illustrates a pinpointing mode for an image area,

FIG. 13 schematically illustrates a stage (or module) for recomposing (or rebuilding) data, the vertical axis materializing the elapsed time,

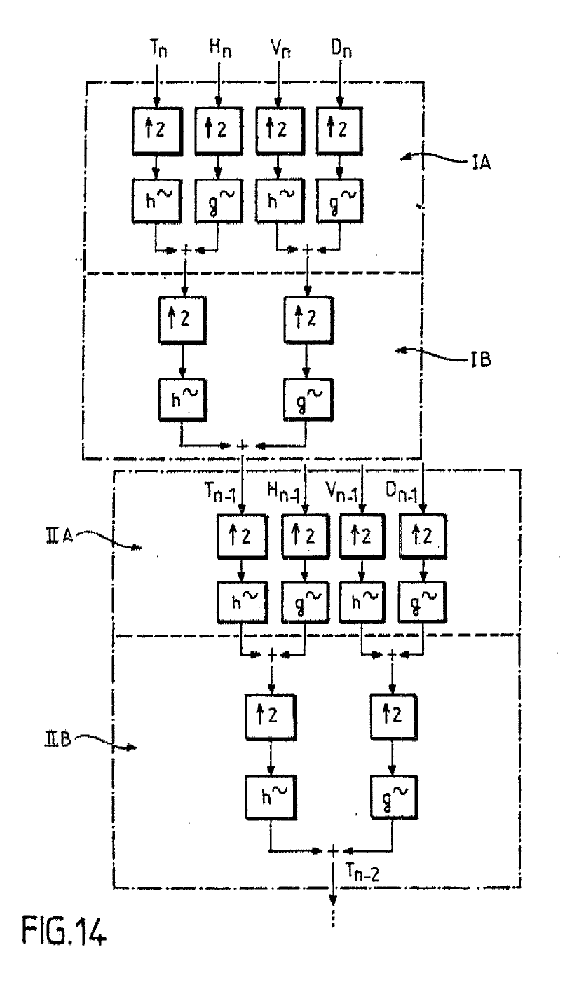

FIG. 14 schematically illustrates two consecutive stages for recomposing the data by means of the wavelet technique,

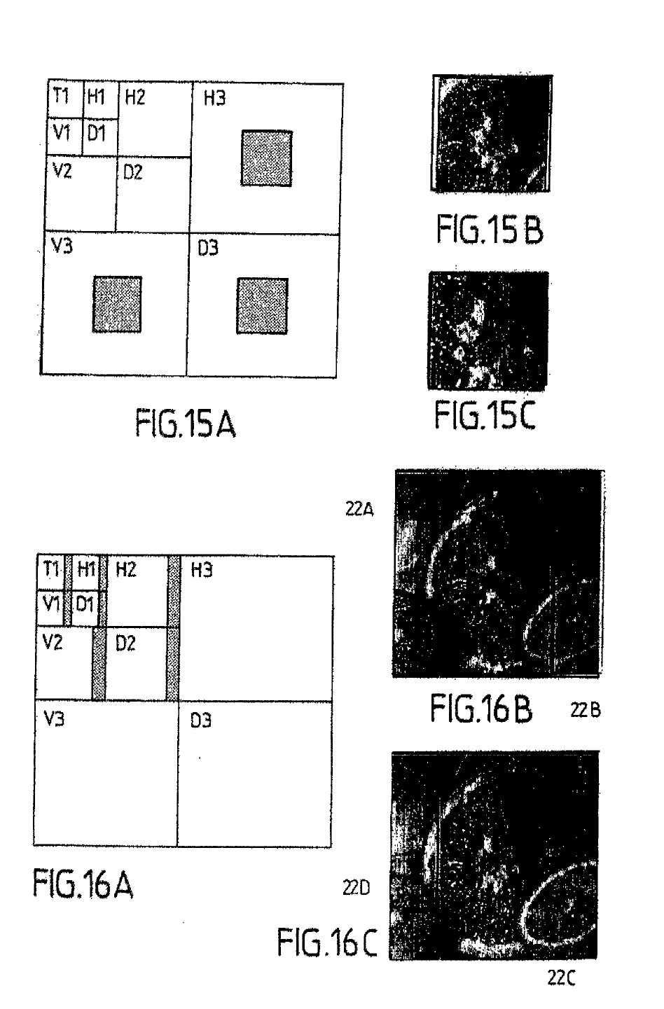

FIG. 15A schematically illustrates the data areas of a multi-resolution configuration which should be transmitted when zooming inside an image, FIG. 15B is a complete image and FIG. 15C is a close-up of the image in FIG. 15B,

FIG. 16A schematically illustrates the data areas of a multi-resolution configuration which should be transmitted when moving within an image, FIG. 16B shows a first portion of an image and FIG. 16C shows a second portion, partly complementary to the image of FIG. 16B, and

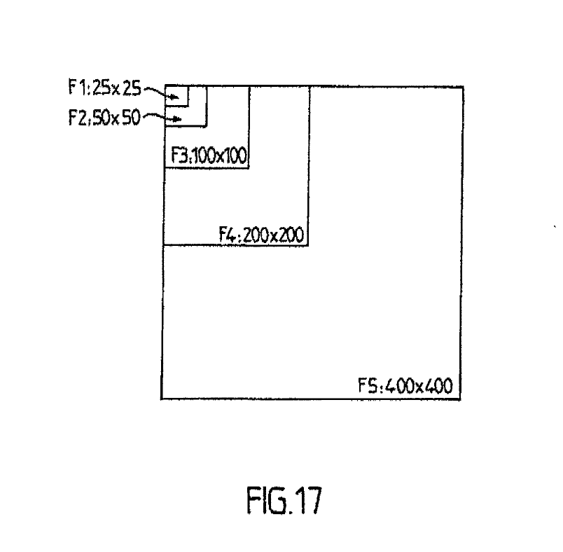

FIG. 17 schematically illustrates the formats (dimensions) of an image, associated with 5 different resolution levels.

The appended drawings are essentially reliable. Therefore, they may not only be used for completing the invention but also for contributing to its definition, if necessary.

In the description which follows, reference will be made to a facility for exchanging image data between client terminals and a server terminal, via a communications network of the public type, such as the Internet. Of course, other types of networks, whether public or private, may also be considered within the scope of the invention.

As illustrated in FIG. 1, a facility according to the invention includes a multiplicity of client terminals 1 which may appear in different forms, and notably in the form of a portable telephone 1-1, a personal digital assistant (better known under the English acronym PDA), a portable microcomputer 1-3 or even of a fixed computer 1-4. These client terminals 1 may be connected to a network, here a public network (the Internet), either through a wiring link or through a wave link. The data communications protocol used may be of any type. As an example, in the case of portable telephones 1-1, it may be of the WAP or BLUETOOTH type.

The facility also includes a server terminal 2 for providing the client terminal 1 with image files in a compressed form and connected to the public network, preferably through a second server terminal 3, for example of the HTTP type (when the network is of an Internet type).

Preferably, the server terminal 2 includes an image data base 4 in which image files are stored in a broken down and compressed form according to a method which will be described later on.

Of course, the image data base 4 might be external to server terminal 2 or distributed on several sites, or might not even exist. In this case, the server terminal 2 is configured so that it may search on the public network, on a request from client terminal 1, for image files including raw data in a standard format, for example “TIF”, “BMP” or “RAW”, in order to compress/break them down and transmit them to it.

Data exchange between a client terminal 1 and tho server terminal 2 is preferably carried out according to the diagram illustrated in FIG. 2.

More specifically, a user who wishes to display on screen 5 (display means) of his client terminal, the whole or a portion of an image, generates a request for accessing this image by means of a user interface 6. To do this, he/she enters information, notably referring to the requested image, then the request is formatted (at 7) and transmitted on to the network (at 8). Its receipt is then acknowledged (at 9) by the HTTP server terminal 3, then the request is transmitted to the server terminal 2 in order to be interpreted (at 10). In fact, requests issued from the client terminal are translated by the HTTP server 3 then transmitted to an extension of the latter (for example CGI) before being sent to the image server terminal 2. Such requests issued from the client are in fact requests specific to the facility, encapsulated in a standard network request, for example of the HTTP type. In the illustrated example, the server terminal 2 includes an image data base 4, so that the image file requested by the user is extracted from it (at 11), then at least certain data of the file (at 12) are formatted, and then the answer to the client's request is emitted (at 13) onto the public network. This answer is received (at 14) by client terminal 1 via HTTP server 3, then rebuilt (or recomposed) and displayed (at 15) on screen 5 of the client terminal 1.

Certain of these steps will be discussed later on.

As mentioned earlier, the image files are preferably stored in a unique format (broken down/compressed) optimized so that the image data may be transmitted gradually (and complementarily). More specifically, the raw data from the image files are first broken down into resolution levels according to a wavelet technique, then broken down into quality layers Lᵢ and finally broken down into elementary blocks (see FIG. 10).

The wavelet technique is well known to one skilled in the art and it will not be described, here again, in detail (see for example, the article of I. Daubechles “Orthonormal bases of compactly supported wavelets”, Communications on pure and applied mathematics, vol. XVI, pp 909-996, 1998).

As illustrated in the upper portion of FIG. 3, the first quality layer provides an important visual contribution while forming a reduced data volume, thus providing fast transmission. As the subsequent quality levels are complementary with each another, the quality may thus be refined. Moreover, there is a very fast trend towards a satisfactory image quality: as illustrated in the lower portion of FIG. 3, this is already almost the case for the third layer L₃.

Now, reference will most particularly be made to FIGS. 4-13 for describing the means which enable terminal 1 and 2 to exchange data, and means for generating files of images in a broken down/compressed format.

When the server terminal 2 is configured in order to carry out the transformation of raw image data into broken down/compressed files, it is provided with a processing module 16, which is built as electronic circuits and/or software modules.

As illustrated in FIGS. 5 and 6, this processing module 16 preferably includes a first stage 17 for applying a chromatic transformation onto the raw image data of an image file (of course if the image is in color). This first stage 17 receives an image, for example in color, represented by three red, green and blue color planes ({R,G,B} space). A change in chromatic space is then performed in order to obtain a new representation space including, for example, a luminance component Y and two chrominance components U and V, wherein both of these latter components are separated from the luminance component Y. Such a change in space, is carried out by a simple matrix operation, by using for instance, the matrix defined by the CIE (Comité International de l'Eclairage). This chromatic transformation is performed because the human eye is less sensitive to chrominance variations than to luminance variations. An ad hoc weighting between planes {U,V} and {Y} is applied during an optimization of the rate/distortion type in order to benefit from this characteristic of the human eye. Of course, other types of color space may be considered. Also, the invention is not limited to images defined in three planes. Spaces of four or five planes, even more, may be considered.

As it will be seen later on, a specific processing operation may be performed when the images are of the “palettized” type. These palettized images are characterized by a restricted number of colors (generally 256) selected, for example, from the sixteen million (2²⁴) possible original colors. In order to regenerate an impression of color gradation, the images are generally post-processed by applying a hue simulation method (called “dithering”), which gives the illusion of intermediate colors by a combination of colors in the neighborhood of each point of an image.

As known to one skilled in the art, these images are difficult to compress by means of the standard encoders because the dithering method is similar to adding noise. In order to limit these dithering effects, firstly, the chromatic transformation stage 17 performs an extension of the original palettized image in {R,G,B} space, which amounts to expressing each pixel of the initial image in {R,G,B} space, wherein only the coordinates relative to the 256 colors of the palette are used, then secondly, to filtering each of the chrominance planes before proceeding with the compression. The filter used is for example a Gaussian type filter. A discrete version of this filter is defined by the convolution mask given below, as an example:

| | | |
|---|---|---|
| 0 | 1 | 0 |
| 1 | 24 | 1 |
| 0 | 1 | 0 |

For this Gaussian filter, a normalization factor of a value equal to 28 should be used.

Such a filter retains the quality of the image and in particular, its contours while significantly improving the efficiency of the compression method by smoothing out the noise generated by the dithering.

The output of the first stage 17 is fed into a second stage 18 for applying to the chromatically transformed (or luminance) data, a wavelet breakdown technique in order to reorganize the image according to revolution levels. As illustrated in FIG. 7, the breakdown is preferably performed by two filters, one of the high pass type, noted g, the other of the low pass type, noted h. These filters are applied to data issued from first stage 17, placed as a matrix form of the type with rows/columns. More specifically, firstly, both g and h filters are applied in parallel onto the different rows of the matrix (portion IA of FIG. 7), then onto the different columns of this matrix (portion IB of FIG. 7).

In the functional diagram illustrated in FIG. 7, the rectangles, where there are vertical arrows pointing downwards and the number 2, refer to a sub-sampling operation for only retaining one image pixel out of two.

At the output of this double filtering, four sub-bands of different kinds are obtained for a given resolution level. The first sub-band H essentially comprises high frequency information on the columns of the data matrix. The second sub-band V essentially comprises high frequency information on the rows of the data matrix. The third sub-band D essentially comprises high frequency information along the main diagonal of the data matrix. Finally, the fourth sub-band T essentially comprises information of the low pass type.

This fourth sub-band T of the third resolution level forms the input for a second wavelet breakdown stage. In other words, the breakdown method illustrated in pass I (A and B) of FIG. 7 is applied in a recursive way (pass II (A and B)), until a selected stop criterion is met, for example when the size of the smallest sub-band is smaller than p pixels.

In FIG. 8, an illustration is found of an example for data organization of the multi-resolution type obtained by a breakdown by means of wavelets. The four squares placed in the left upper portion and referenced as T, H1, V1 and D1, refer to the four sub-bands of the third resolution level (the lowest resolution). Sub-bands H2, V2 and D2 refer to sub-bands of the second resolution level. Sub-bands H3, V3 and D3 refer to sub-band of the first resolution level (the highest resolution).

The output of the second stage 18 is fed into a third stage 19 which provides the breakdown into quality layers Lᵢ. An exemplary embodiment of this third stage 19 is illustrated in FIG. 9.

The image broken down beforehand into sub-bands SB by the second stage 18, undergoes a first optimization cycle (Opt) during which a value for the quantification step q_{1,j} is determined for each sub-band SB₁ of the first quality layer. This optimization cycle is controlled by an external parameter which is either the number of bytes R₁ assigned to the first quality layer L₁ (the lowest quality), or a measure of the expected quality for the given layer. This number is first set according to the type of processed image.

The set of quantification step values q_{1,j} forms a bank of quantifiers BQ₁ which are applied to all the sub-bands SBⱼ and which delivers at the output primary data for the first layer L₁. A replica of these primary data is fed into a dequantification bank BQ⁻¹₁ which delivers at the output, approximations Ê_{1,j}, optimal for each of the original sub-bands SBⱼ of the different resolution levels, with knowledge of the number of bytes assigned to the first layer L₁. These approximations Ê_{1,j} and the original sub-bands SBⱼ are fed into a subtraction operator which delivers at the output, error sub-bands E_{2,j} which will, in turn, undergo an optimization cycle of the type of that which has just been described for the first stage in order to deliver at the output, primary data for the layer L₂ of the second level and error sub-band for the layer L₃ of the third level.

This breakdown method may be continued recursively as long as the error sub-bands E_{1,j} remain non-zero, or else as long as they remain greater than a selected threshold. Below this threshold, it may be considered that it becomes unnecessary to store or transmit information (compressed data) as the gain in quality is imperceptible.

Of course, to each optimization cycle, associated with each quality layer Lᵢ, there corresponds a set number of bytes Rᵢ. The number of bytes Rᵢ associated with each quality layer enables the image transmission period to be adapted when the rate (or more generally the performances) of the communications network is (are) known. In this way, a first image may be displayed on the client terminal 1 upon receiving the data front the first layer L₁ and this image may be refined upon receiving the data from the layer L₂. This process may be repeated for the relevant image as many times as there are quality layers defined by the server terminal 2. The graduality level may be increased, by increasing or reducing the number of quality layers, i.e. the number of the different quality levels. This gradual rebuilding of the image will be detailed later on with reference to FIGS. 13 and 14.

A particular case should be considered here. This has to do with client terminals of the portable type which generally do not have the capability of a so-called “real color” display, i.e. of the red, green and blue type with 24 or more bits. The definition of screens of this terminal type is often limited to 8 bits. De facto, client terminals use a color palette for displaying the images, like for example a table specifying 256 colors (2⁸) selected among 2²⁴ for displaying the image. Two types of palettes exist presently: fixed palettes which are specific to a terminal and adaptive palettes which may change depending on the contents of the image to be displayed. The following will be limited to this last category of adaptive palettes.

The adaptive palettes depend on the image to be displayed, they fully form a type of image data and consequently, they are transmitted at the same time as the latter. Determination of the optimal palette actually requires knowledge of the original image, before palettization. This notion of adaptive palette is of course extended to grey level images.

Within the context of gradual transmission according to the invention, the palette is transmitted in several, preferably four, steps. In order not to sacrifice the quality of image restoration, only transmitting the most representative 64 colors in the first quality layer L₁ (the lowest quality) may be contemplated. Indeed, the first layer L₁ the most often corresponds to a very high compression of the image, or in other words to very large quantification steps for each of the sub-bands SBⱼ. The image which will subsequently be rebuilt is then much more poor in colors, in such a way that it is unnecessary to associate with it and so transmit the whole set of the 256 colors of the palette. 64 new colors are then transmitted with the second layer L₂. On receiving both layers L₁ and L₂, the client terminal has then at its disposal 128 colors for displaying this image, whereby the 128 remaining colors are transmitted with the third data layer L₃. This gradual palette transmission is particularly interesting for terminals with a small display size, typically less than 200×200 pixels, like in the case of portable telephones. Actually, for this type of terminal, the complete palette represents up to 50% of the data relative to the image portion to be displayed for the first data layer L₁. Consequently, by only transmitting the quarter of the palette with the first data layer L₁, the volume of data transmitted is reduced by about 38% for a restored image quality similar to the one obtained if it had been decided to transmit the whole of the palette.

The successive breakdowns into wavelets and into quality layers, according to the invention, provides complementarity as regards resolution and quality, of the data contained in the different layers Lᵢ.

The output of the third stage 19 is fed into a fourth stage 20 designed for providing breakdown of the sub-bands of each quality layer Lᵢ into elementary blocks for BEC encoding.

In this fourth stage 20, tiling of the different sub-bands of each quality layer is performed in order to provide fast handling of the local data relative to a region of the image for a given resolution level. In other words, each sub-band H, V, D of a given resolution level of a given quality layer is broken down into elements Bₕ, Bᵥ or B_{d} which refer to an area of the given image. According to the invention, each element Bₖ (here K=H, V, D) associated with an area of the pre-defined image, is extracted from a sub-band of a given resolution level of a given quality layer and concatenated with two other elements of two other sub-bands of this same resolution level, referring to the same area of the image. This concatenation of the three elements Bₖ, forms an elementary block for BEC encoding.

Preferably, before proceeding with the concatenation of these three elements, element Bᵥ undergoes a 90° rotation followed by a symmetry of the horizontal type, as illustrated in the right-hand portion of FIG. 10. The performance of entropic encoding may thus be increased, which is applied to each elementary encoding block for BEC encoding in order to obtain BECH elementary entropically encoded blocks. Entropic encoding consists in compressing the incoming data without loss of any information. To do this, use is made of the statistical properties of the input data. The assignment of the number of bits for representing an input datum is inversely proportional to the frequency of occurrence of the latter in the input flux. Long symbols are used for representing rare data whereas short symbols (low number of bits) are used for representing frequent data in the data flux considered. Complementary details on the entropic encoding technique may be found in the document, Information Technology “Digital compression and coding of continuous-tone still images”, Annex C. ISO 10918-1.

At the output of the fourth stage 20, broken down and compressed data are available which may then be stored in the data base 4, for example. As illustrated in FIG. 11, as an example, such a file may comprise three types of information: a general header, specific headers and compressed data (entropically encoded elementary blocks, BECHₙ) separated from each other by delimiters.

The image header preferably provides the general characteristics of the image, i.e. its number of resolution levels, its definition, its number of chromatic planes, optional copyright information, printing information, etc. The specific headers may be of at least three types: chrominance plane, quality layer and resolution level. These three types of information may be accompanied by complementary information mentioning the location for example, where the next header of the same type may be found. Actually, as the data associated with these headers is of a complementary nature, it is advantageous to be able to move around very rapidly in the storage structure (for example the data base) when extraction of specific (possibly complementary) data is desired in order to meet the request of a client.

Finally, the delimiters are preferably placed at the beginning of each entropically encoded elementary block, BECH. Advantageously they are aligned within a byte in order to provide greater speed in searching for the beginnings of entropically encoded elementary blocks, BECH.

Such broken down and compressed images, optionally stored as a file on a storage medium, exhibit at least four organizational properties. First of all, image data are organized in complementary resolution levels and in complementary quality layers. Next, for each specified resolution level, it is possible to spatially access data within the image. Moreover, the image may be accessed according to an increasing quality level. Finally, through this organization of complementary data based both on resolution and on quality, a storage file may be obtained with a unique format.

In order to draw maximum benefits from the properties imparted by the compression/breaking down of image data, the requests and the exchanged answers between the client terminals and the server terminal should exhibit certain characteristics. At least, the request emitted from a client terminal includes the designation of an image, for example the name of the image file stored in the data base 4 of the server terminal (or the address where it may be found), accompanied by at least certain of the display characteristics of the display means (screen 5) of the requesting client terminal. For instance, the request may include the display format (or the resolution) of screen 5, or of a portion of this screen where the image should be displayed, optionally accompanied by the number of encoding bits for each display pixel. For example, the image format may be of the 120×120 pixel type and the number of bits equal to 8 (in this case, the request includes information of the “120×120×8” type).

On receiving this request, the processing module 16 of server terminal 2 extracts the information referring to the image file and to the display characteristics of client terminal 1. It then identifies the format of the stored image and its different quality layers. For example, the image may be stored in a format of the 400×400 pixel type, with five quality layers L₁-L₅.

Each quality layer is broken down into resolution levels which individually correspond to image formats (dimensions, here), as illustrated in FIG. 16. Here, the first format (F₁) corresponds to a format of type 25×25 pixels, the second format (F₂) corresponds to a format of type 50×50 pixels, the third format (F₃) corresponds to a format of type 100×100 pixels, the fourth format (F₄) corresponds to a format of type 200×200 pixels, the fifth format (F₅) corresponds to the format of type 400×400 pixels.

The processing module 16 of server terminal 2 performs a comparison between the display characteristics (120×120×8 here) of the client terminal and the different display characteristics (format) of the stored image. It is important to note that a given quality layer corresponds to several resolution levels, and that consequently, depending on the display resolution of the client terminal, only certain resolution levels (and not the whole of them) of the quality layers are transmitted. The highest resolution level (i.e. the type of image data) compatible with the display characteristics of client terminal 1 (i.e. the one which is the closest to the characteristic of client terminal 1) is therefore inferred by module 16. In this example, this is the third format F3 which corresponds to the 100×100 format (see FIG. 17) and is the closest to the 120×120 display format of the client terminal. Next, the processing module 16 determines the data from the broken down/compressed file which correspond to the highest resolution level as determined earlier, here, the third level. More specifically, the processing module extracts the data associated with the third level of the different quality layers.

Depending on the characteristics (performances) of the network, and more particularly depending on its throughput, the processing module transmits either a unique answer including data from the different quality levels for the determined resolution level, or three successive answers including, for the first one, data associated with the first quality layer L₁, for the second one, data associated with the second quality layer L₂ and for the third one, data associated with the third quality layer L₃. In either case, the image corresponding to the highest quality is rebuilt (or recomposed) from the three received quality layers by the processing module 21 of the client terminal 1, which will now be described with reference to FIGS. 13 and 14.

This processing module 21, which is built as electronic circuits and/or software modules, receives an answer from the server terminal 2, including the broken down/compressed data which correspond to its request for accessing an image, or to a portion of the latter. It includes a stage 22 for rebuilding the image as the different quality layers Lᵢ are being received, which guarantees a selected ratio: quality/number of received bits. Of course, it is possible to rebuild an image at any time, before having completed reception of a quality layer, but in this case, the aforementioned selected ratio cannot be guaranteed. The rebuilding mode illustrated in FIG. 13 is the dual of the one illustrated in FIG. 9. More specifically, the data from the first quality layer L₁ are fed into a first dequantification bank BQ⁻¹₁ which delivers sub-bands SB₁ which are in turn, subject to an inverse transformation W⁻¹ (detailed later on with reference to FIG. 14) delivering, at the output, the image data from the first quality layer (i.e. the one providing the least good quality). These data are then transmitted to the display means so that a first image, from a first quality level, is displayed on screen 5.

When the data from the second layer L₂ reach the reconstruction stage 21, they are fed into a second dequantification bank BQ⁻¹₂ which delivers, at the output, sub-bands associated with the second quality level which are then combined with the first sub-band SB₁ of the first quality level (first quality layer L₁) in order to form the second sub-band SB₂ associated with the second quality level. The latter are then submitted to an inverse transformation W⁻¹ which provides image data D₂ associated with an image of second quality level (second quality layer L₂).

What has been stated for data from the second quality level is also applied to data from the third, the fourth and more generally the M^{th} quality layers, whereby the combination of sub-bands is always dealing with new sub-bands of the M^{th} level combined with those of level M−1.

In this way, as soon as quality layer Lᵢ is available, it is combined with the layers received earlier (L₁ to Lᵢ₋₁) and it replaces the earlier image (of lower quality), so that the quality of the image gradually increases. In other words, sub-bands SB1 of the first level are used for forming the first display image then upon receiving the sub-bands of the second layer, the first sub-bands SB1 are stored and the received sub-bands are combined with SB1, providing second sub-bands SB2 which are used for forming the second display image. The second sub-bands SB2 are then stored, preferably in the place of the first sub-bands SB1, then combined with sub-bands of the third layer in order to form the third sub-bands SB3 which are used for forming the third display image, and so forth.

Preferably, the sub-bands SB are stored in a memory 23 of the client terminal 1, so that they may be at least partially reused when answering complementary access requests,

Two consecutive stages of the module for the inverse transformation W⁻¹ which implements a wavelet synthesis are illustrated in FIG. 14. The h˜ and g˜ are the duals of the h and g filters described earlier with reference to FIG. 7. Each stage I(A and B), II(A and B), . . . provides the transition from a resolution level of n to a resolution level of n−1.

The data from the sub-bands Tn, Hn, Vn, and Dn for the highest resolution level (here, n) are applied on supersamplers (materialized by rectangles where there is a vertical arrow pointing upwards and the number 2), followed by the h˜ or g˜ filters, with which a synthesis may be performed on the matrix columns after having summed the routes 2 by 2 (portion IA). Each summation output is fed into a new supersampler followed by a new h˜ or g˜ filter, with which a synthesis may be performed on the matrix rows after having summed both routes (portion 1B). The summation output is then fed into the sub-band T input of a new stage including three other inputs for sub-bands H, V and D fed by data from resolution level n−1, in order to repeat the synthesis operation carried out in the previous stage, and so forth for each resolution level.

Up to now, the issue was a request for accessing the whole of an image. Of course, the invention is not limited to this type of request. Indeed, a user who already knows an image, for example because he has requested it earlier, may ask the server terminal 2 to send him only a portion of an image (close-up), possibly with a higher image quality, for example as specified in his request. In this case, the request includes information referring to the position of the requested image area and its dimension. For example, the request may include two pairs of coordinates (X1,Y1) and (X2,Y2) which define the positions of two opposite corners of a rectangle, as illustrated in FIG. 12. Preferably, the position coordinates are of the absolute type, i.e. defined with respect to an origin of reference, for example the upper left corner of the complete image, referred to by coordinates (0,0).

The request for accessing this area of the image then includes the name of the image file, and the designation of the image area, for example in the format “50+50+150+150” which indicates that the client wishes to obtain the image data which are lying between pixels of coordinates (50,50) and (150,150). Preferably, this request also includes information related to image quality and to the format of the image requested earlier. For this purpose, the answer which the server terminal 2 sends to a client terminal 1, upon a request for accessing a first image, includes several pieces of information, and notably the format of the complete image, in its highest resolution, for example a format of the 400×400 type and maximum image quality, for example equal to 5, a piece of information related to the image quality and to the format of the image which is transmitted, for example a format of the 100×100 type, and a defined resolution, for example equal to 3, which is compatible with the display format of the client terminal 1.

In this way, when the server terminal 2 receives a new request (complementary) from a client terminal 1, it has the information which will allow it to only extract data which have not yet been transmitted, and which correspond to the area requested by the client, without having to store its earlier requests. The processing module 16 of the server terminal 2 has now only to extract the resolution level data from the quality layers, preferably from the highest to the lowest, which will meet the client's request and be compatible with the display characteristics of its terminal.

To do this, the processing module 16 performs a comparison between the display characteristics of the client terminal (here: 100×100×8) and the display characteristics which are associated with different resolutions of the image quality layers. It then selects the display characteristics which are the closest to (compatible with) those of the client terminal, taking into account the dimensions of the image area requested by the client. In the selected example, the dimensions of the image area and the display format of the client terminal allow a resolution level of 5, and consequently a higher resolution than the one selected earlier (level 3). The processing module then extracts from the broken down/compressed file, the data which correspond to the image area requested by the client and associated with the fourth and fifth resolution levels of the different quality layers. Indeed, it is unnecessary to send the data of lower resolution levels, once again to the client terminal, because the latter data have been sent as an answer to the earlier request and stored in memory 23.

Upon receiving this answer, the processing module 21 of the client terminal 1 has only to feed its rebuilding stage 22 with data so that it rebuilds the image corresponding to the requested image area, with the fifth resolution level as determined by the server terminal, from the received new data and stored sub-bands SB3 (and corresponding to resolution levels 1-3 of the different quality layers). Of course, it is possible to rebuild an image at any time, before having completed reception of a quality layer, but in this case, the selected quality/number of bits ratio cannot be guaranteed. This applies more particularly to slow networks, for which rebuilding is performed only after having completed reception of a complete quality layer.

This request example enables a user to perform a close-up (or zoom) on a portion of an image, as illustrated in FIG. 14. More specifically, FIG. 14A illustrates the multi-resolution organization (of order 3) of a broken down/compressed image according to the invention. FIG. 14b corresponds to the transmission of a complete image, for example, whereas FIG. 14C is a close-up (or zoom) of the central portion of image 14B, which corresponds to the grey tinted squares of FIG. 14A in the sub-bands of the third resolution level. In this example, only data associated with the grey tinted squares of the three sub-bands of the third resolution level will be transmitted to the client, as the data from the lower resolution levels were transmitted earlier.

As illustrated in FIG. 16, the invention also allows displacements within an image. Indeed, two cases may be encountered: a first case wherein, even with the lowest resolution level, the client terminal has insufficient display characteristics for displaying the whole of an image, and a second case wherein the client deliberately chooses to only display a portion of an image.

In the illustrated example, FIG. 16A illustrates the multi-resolution organization, over four resolution levels, from the complete image of FIG. 16B. More specifically, in this FIG. 16B, two areas may be distinguished, a main area 22A which is the one displayed on screen 5 of the client terminal and an area 22B which may be termed as virtual to the extent that it is not displayed on this screen 5 because it has not yet been sent to client terminal 1. The data of portion 22A of FIG. 16B correspond to blank areas of sub-bands T₁, H₁, V₁, D₁, H₂, V₂, and D₂, Of the multi-resolution organization of FIG. 16A. In other words, only data associated to these portions or the sub-bands of the first and second resolution levels have be transmitted in answering to a first request for accessing a portion of an image. In a second access request, the user client tells the server terminal 2 that he wishes to move towards the right of the image, so that the portion 22C of the image of FIG. 16C is displayed on his screen 5, and not the portion 22D of this same image (viewed earlier).

Upon receipt of this new request, the server terminal compares the image areas transmitted earlier with the area freshly requested by the user. It thus determines one or several non-overlapping areas from which it will extract the broken down/compressed data (which correspond to the grey tinted rectangles of the sub-bands of resolution levels 1 and 2 of FIG. 16A) in order to transmit them to the client terminal 1, so that its rebuilding stage 22 combines these fresh data with the old ones, then displays the portion 22C of the image of FIG. 16C on screen 5.

The efficiency of a spatial displacement within an image directly results from the decompressed/broken down file according to the invention, and more particularly from its breaking down into elementary blocks with BECH encoding. Actually, the elementary BECH encoding blocks enable the image to be rebuilt locally and because of their complementarity, by knowing a BECH block adjacent to already known blocks, the coverage of the image may be increased.

With such a complementarity of transmitted data, the period required for transmitting the image data may be minimized and consequently the transmission costs may be lowered for a given quality upon receipt.

It is important to note that intermediate resolution levels, i.e. that do not correspond to the resolution levels of the original broken down/compressed image, may be obtained through interpolation functions.

Of course, requests and consequently answers may include information other than that described earlier. Notably, requests may include information related to the acceptance of adaptive palettes, information related to the memory capacity and to the CPU of the client terminal (and more generally to any other type of data specific to the client terminal), a specific level quality, a range of quality levels, gradual palette information.

More specifically, requests may include the types of variables mentioned hereafter.

A first type is related to so-called absolute identification variables: these variables define a portion of an image for which interpretation on the client terminal directly provides a result interpretable by the user. An absolute identification is used in order to guarantee that the same request emitted on any type of client device provides the same result in terms of visible image area.

A second type is related to so-called optimization identification variables: these variables define a portion of an image for which the interpretation on the client terminal's side should be combined with other data transmitted earlier, in order to obtain a result interpretable by the user. Identification optimization is used in order to minimize the number of transmitted data, for example in the case when the user requests a displacement within the image or a close-up (only information which is complementary to that which was transmitted earlier, is sent to the client terminal).

As an example, certain absolute identification variables are specified hereafter.

A variable “name” refers to an image file.

A variable “access type” may assume the value, “relative” or “direct”. It requires area coordinates as well as a quality level if its value is “direct”. By “relative”, it is understood that the area coordinates are relative to the highest resolution level of the image, whereas by “direct”, it is understood that the area coordinates are based on a selected resolution level and specified by the resolution level variable.

A variable “area coordinates” requires the presence of the variable “access type”. For example, this means two pairs of position coordinates which define a rectangular area (or some other one) of an image. Depending on the value of the variable “access type”, coordinates are relative to the highest resolution level of the image or to the resolution level specified by the variable “resolution level”.

A variable “resolution level” requires the presence in a request of the variable “access type” along with the value “direct”. This variable “resolution level” may assume values between 1 and n, the value 1 referring to the lowest level.

As an example, certain optimization identification variables are specified hereafter.

A variable “current resolution level” requires the presence in a request of the variable “access type” with the value “relative” as well as the presence of the variable “current area coordinates”. This resolution level variable may assume values between 1 and n, the value 1 corresponding to the lowest resolution level. This variable provides the processing module which answers, an indication relative to what should be answered in the case of an optimization request of the displacement or close-up (or zoom) type. For example, if the displayed (current) image has a resolution level of order 2 and if the client requests a close-up on an area which requires a resolution level of order 4, only the portions of the sub-bands of levels of order 3 and 4 will be transmitted (instead of transmitting all the data corresponding to resolution levels from orders 1-4, if this information had been omitted).

A variable “current area coordinates” requires the presence in the request of the variable “current resolution level”. For example, this means two pairs of position coordinates which define a current visible rectangle according to a current resolution level. The complementary information to be extracted is inferred from these data and the area coordinates by the processing module which answers.

A graduality range comprising different quality levels may be defined by two variables “lower limit” and “upper limit”.

The variable “lower limit” may assume values between 1 and n. Value 1 corresponds to the lowest quality, although it provides an optimal compromise between the number of bits transmitted (minimum) and the displayed result. The quality values are determined up to the upper limit value, when the latter is specified in the request, or else until the highest quality is obtained. When this variable is not specified, it is interpreted as having a value equal to 1. Moreover, when the variables “lower limit” and “upper limit” have the same value, a unique value is determined.

The variable “upper limit” may assume values between 1 and n, value 1 being the smallest. This variable is generally used with the variable “lower limit”, both variables define the graduality range to be determined. It may be used for forcing extraction of the image data according to a set quality level. When this variable is not specified, it is considered that all the quality layers are requested from the value of the variable “lower limit”.

A variable “limiting dimension mode” requires the presence in the request of the variable “limiting dimension”. It may assume for example three values “increased”, “closest” and “exact”. This variable is used for limiting the size of an answer. When it has the value “increased”, it indicates the maximum number of bits that the image data should not exceed. The size of the data of the answer should be smaller or equal to the specified size. When it has the value “closest”, the answer should be adjusted according to the number of bits specified by the variable “limiting size”. This adjustment should take into account the possible indivisible character of part of the answer's data. The answer should comprise integer data units up to the value of variable “limiting size” in bytes, with a tolerance of plus or minus one dimension of data units when the variable “limiting size” is between the boundaries of a data unit. When the variable has the value “exact” an answer should be returned for which the data dimensions are equal to the bytes of the limiting dimension.

A variable “limiting dimension” requires the presence in the request of the variable “limiting dimension mode”. It may assume values between 1 and n. It enables a number of bytes to be defined for limiting the dimension of the answer. The interpretation of this variable depends on the value of the variable “limiting dimension mode”.

A variable “limiting offset” requires the presence in the request of the variable “lower limit”. It may assume values between 1 and n. It is used for defining the number of bytes representing an offset in the graduality range specified by the variable “lower limit”. It is used for extracting complementary data after receipt of an answer limited in dimension by the use of variables “limiting size” and “limiting size mode”.

A variable “palette” may assume for example, the three values “gradual”, “complete” and “none”. This variable may only be used when the image designated by variable “name” contains palette information. When its value is set to “gradual”, the variable “palette from” provides details on the graduality levels (as indicated earlier, the palette may be returned in several pieces). When its value is set to “complete”, the whole of the palette is sent in an answer. When its value is set to “none”, no palette information is returned. When this variable is not specified, but the image contains a palette, it is considered as being set to value “complete”.

A variable “palette from” requires the presence in the request of the variable “palette” with the value “gradual”. It may assume values between 1 and n. It specifies the first palette fragment which should be sent. One palette fragment should be sent per graduality range (until all the available palette fragments have been transmitted). It is important to note that it is possible to request a palette fragment equal to 3 with a graduality range equal to 1. This may be useful when, because of an earlier request, palette fragments of levels 1 and 2 were transmitted, the current request then specifying a different image area requiring the transmission of a graduality range of order 1 (only the palette fragment of order 3 is lacking so that it is required at that time).

A variable “offset” may assume values between 1 and n. As this variable is optional, when it is not specified, a complete answer is transmitted to the requesting processing means. It is used when the processing module which ought to answer, is unable to transfer its data in a single answer (for example in the WAP protocol without SAR). This offset variable is relative to the first byte of the answer, including the header.

As mentioned earlier, the processing means for the server terminal 2 may be built as a dedicated electronic card and/or software modules. Consequently, they may be part of or may comprise an image data transmitting device which may be implemented in a server terminal. This note also concerns transformation means which may be implemented either directly in the server terminal, or in an auxiliary terminal dedicated to the compression/breakdown of image files and connected to the server terminal which, in this case may be a service web site, for example.

Also, the processing means for client terminals 1 may be built as a dedicated electronic card and/or software modules. Consequently, they may be part of or may comprise an image data receiving device which may be implemented in a terminal. In the case of software modules, they may be either pre-stored on a memory medium, such as a CD-ROM, then loaded on the client terminal, or exported from a web site (for example via the communications network).

The invention is also related to a method for implementing the facility and the devices introduced above. This method has already been discussed earlier, so that only its main characteristics will be detailed hereafter.

The method according to the invention includes at least:

first step for generating a request for accessing an image, including display characteristics of the display means of the requesting client terminal (for example, the format (or the dimensions) of the data display area and/or the number of encoding bits for the display pixels and/or the number of colors), and

a second step wherein i) display means characteristics are extracted from the access request (more specifically the display capabilities), ii) a correspondence is established between at least a type of image data (colors or grey level, resolution, quality) and display characteristics, and iii) from the display characteristics corresponding to the different types of image data, those which are the closest to the extracted display characteristics are determined according to a selected criterion, so that the image data associated with the type(s) of data corresponding to the determined characteristics are transmitted to the client terminal.

Advantageously, during the second step, the quality layers are generated so as to be complementary with each another and the transmitted image data comprise image data associated with at least a portion of the different quality layers (form the highest to the lowest), i.e. those which correspond to the type(s) of data compatible with the display characteristics of the client terminal.

Consecutively to a first series of first and second steps, a piece of information referring to an image area may be placed in a fresh access request so that the server terminal will transmit the image data associated with this single area. Consequently, in answer to a first step for generating a request including a piece of information on an image area, in a second step, on the one hand, this area information is extracted in order to determine the associated display characteristics and on the other hand, from the display characteristics which correspond to the different resolution levels (via the different types of image data), those which are the closest to the display characteristics associated with the area, are determined in such a way that the image data associated with at least a portion of the different quality layers are transmitted to said client terminal, which data are those which are associated with the highest resolution level corresponding to the determined characteristics and which have not been transmitted earlier (during previous answers).

Moreover, consecutively to the receiving of first and second requests for accessing an image, including first and second pieces of area information respectively, in the second step, on the other hand, a comparison is performed between these first and second pieces of area information in order to determine one or several possible non-overlapping areas, and on the other hand, the image data associated with this non-overlapping area are transmitted, according to quality layers and to resolution levels adapted to the display characteristics of the client terminal and/or to the needs of the application.

During this first step, a piece of information designating a given resolution level may also be placed in the access request. In this case, during the second step, firstly, extraction of data associated with this resolution level in the different quality layers is performed, and it is checked whether this level is compatible with the display characteristics of the client terminal, and secondly, the data associated with this resolution level are transmitted.

Preferably, during the second step, information referring to their quality layer is transmitted with the image data, so that the requested image is rebuilt from data received in answer to each of the access requests relative, to this image.

The method may also include a data transformation step wherein firstly, a chromatic transformation is applied to “raw” image data, contained in a primary file, in order to obtain transformed data, as a row/column matrix, in a three-dimensional representation space including, for example a luminance component (Y) and two chrominance components (U,V), secondly, a wavelet breakdown technique is applied to the transformed data in order to obtain different resolution levels, thirdly, a technique for breaking them down into quality layers is applied to these resolution levels, fourthly, a first function for breaking them down into elementary encoding blocks is applied on the quality layers, and fifthly, this breakdown is stored in a secondary file. Such a transformation step may be performed either before the first and second steps in order to generate broken down/compressed image files or consecutively to a first step.

Of course, other types of color space may be considered. Also, the invention is not limited to images defined in three planes. Spaces of 4 or 5 planes, or even more, may be considered.

More specifically, during this transformation step, on the one hand, the breaking down of data transformed into a row/column matrix is performed by applying a low pass filter (g) and a high pass filter (h) in order to obtain for each resolution level, a first sub-band (h) including high frequency information on the columns, a second sub-band (V) including high frequency information on the rows, a third sub-band (D) including high frequency information along the main diagonal of the matrix and a fourth sub-band (T) including information of the low pass type, and on the other hand a quantification technique with stages for generating complementary quality layers is applied on the sub-bands.

The quantification technique carried out during this transformation step advantageously consists of:

a first phase wherein an optimization function depending for example on a certain number of bytes dedicated to a data layer (Lᵢ) is applied on sub-bands of different resolution levels, in order to determine for each sub-band, a quantification step (q_{1,j}), the set of step values forming a quantification bank (BQ₁), then for each sub-band, the corresponding quantification step (q_{1,j}) is applied in order to obtain the data associated with layer (Lᵢ),

a second phase wherein a dequantification bank (BQᵢ⁻¹), the inverse of quantification bank (BQᵢ), is determined, then this dequantification bank is fed with data associated with quality layer (Lᵢ) and with the values of the quantification steps (q_{1,j}) in order to determine an approximation for each sub-band which is then subtracted from the sub-band Eᵢ of the previous step in order to obtain error sub-bands (E_{i+1,j}),

a third phase wherein the first, second and third phases are repeated with another number of bytes dedicated to another quality layer (Lᵢ₊₁) (preferably, selected according to data throughput characteristics of the network to which the client terminal is connected), in order to obtain data associated with this other layer (Lᵢ₊₁) and new error sub-bands, as long as the respective contents of the error sub-bands (E_{i+1,j}) remain above selected thresholds whereby the breaking down into quality layers terminates in the opposite case.

Moreover, in this transformation step, the first function advantageously consists firstly, in breaking down the first (H), second (V) and third (D) sub-bands of each resolution level of each quality layer (Lᵢ) into components associated with regions of the image, secondly, in concatenating elements of each sub-band of a same resolution level, associated with identical regions, in order to form elementary encoding blocks (BEC) each including three elements, one of the elements of each block having undergone a rotation and a mirror symmetry beforehand, and thirdly, in carrying out an entropic encoding of each elementary block in order to obtain entropically encoded elementary blocks (BECH).

Advantageously, when the network has very low data throughput characteristics and when the transmission protocol does not allow the client to interpret the answer until it has been received entirely, firstly, during the second step, all the image data associated with at least a portion of the quality layer, corresponding to the display characteristics of the client terminal, are transmitted within successive answers, each including complementary data associated with layers of increasing quality, and on the other hand, upon receiving the successive answers, the transmitted image is rebuilt gradually until the highest quality level is achieved.

In this case, rebuilding preferably consists of:

a) applying to a first received quality layer (Lᵢ) the dequantification bank (BQᵢ⁻¹) associated with this layer in order to rebuild the sub-bands (SBᵢ) which it contains and applying an inverse transformation to the sub-band, in order to rebuild the image data of this layer to be displayed,

b) applying to a second received quality layer (Lᵢ₊₁) the dequantification bank (BQᵢ₊₁⁻¹) associated with this layer in order to rebuild the sub-bands (SBᵢ) which it contains and merging them with sub-bands from the previous layers, then applying onto these merged sub-bands, the inverse transformation in order to determine fresh image data to be displayed, and

c) repeating step by for each of the following quality layers by merging at each time, the sub-bands which it contains with those from the previous layers.

The invention is definitely of interest in the case of compressed image transmission. Actually it may handle any type of image format, which meets the previously stated properties. Actually it provides identification of the elementary encoding blocks without any ambiguity, which are required in the two following situations:

during a first display of an image: the client does not have the data relative to the image which he wishes to display, so that on the basis of transmitted information, he is provided with a complete version of the image under a resolution which is suitable for his terminal;

during a second display of an image: the client already has a portion of the data relative to the image which he wishes to display. In this case, the necessary complementary data are easily inferred by considering the coordinates of the presently displayed image area, the coordinates of the future displayed area and the display characteristics of the client terminal. According to the wish of the client that he may examine such and such region of the image (specified at maximum resolution), which may be extended more or less, the resolution level of the image to be transmitted to the client is inferred according to the format (for example the display dimensions) of the latter.

It is important to note that information relative to the terminal of a client is separate from that characterizing the area to be displayed, so that a same image may be exchanged between two client terminals which do not necessarily have the same characteristics.

The invention is not limited to the embodiments of the device, of the installation and of the method described above, only given as examples, but it encompasses all alternatives which one skilled in the art may contemplate within the scope of the claims hereafter.

1. An image data exchange facility between client terminals and at least a service terminal, wherein each client terminal (1) includes data display means (5) and first processing means (21), and is configured for sending to said server terminal (2) requests for accessing images, broken down into resolution levels and quality layers, in order to display these data after recomposition,
characterized in that said first processing means (21) are configured for placing in an access request, display characteristics of display means (5) of the client terminal (1) wherein they are implemented, and in that server terminal (2) includes second processing means (16) configured for i) extracting from a request for accessing an image, received from a client terminal, the characteristics of its display means (5), ii) establishing a correspondence between at least a data type of the image and display characteristics, and iii) determining, according to a selective criterion, from the display characteristics corresponding to data types of the image, those which are the closest to the extracted display characteristics, so that the image data associated with the image data type corresponding to the determined characteristics, are transmitted to said client terminal (1).

2. The facility according to claim 1, characterized in that the quality layers are complementary.

3. The facility according to claim 2, characterized in that second processing means (16) are configured in order to transmit to a client terminal (1), which has sent an access request, image data of at least a portion of the quality layers, associated with the image data type corresponding to determined display characteristics.

4. The facility according to any of claims 1 to claim 3, characterized in that the display characteristics include at least a data display area format of the display means (5), corresponding to a resolution level.

5. The facility according to any of claims 1 to 4, characterized in that the display characteristics further include a number of encoding bits for the pixels of the display means (5).

6. The facility according to any of claims 1 to 5, characterized in that the second processing means (16) are configured for sending to the first processing means (21), of a client terminal (1) which has sent an access request, together the determined image data and the resolution level of the data of this image.

7. The facility according to any of claims 1 to 6, characterized in that the first processing means (21) of client terminal (1) are configured for placing in an access request a piece of information referring to an image area of image data so that said second processing means (16) transmit the image data associated with said area.

8. The facility according to claim 7, characterized in that said second processing means (16) are configured for i) extracting from the access request said area information in order to determine the associated display characteristics, ii) determining from the display characteristics corresponding to data types of the image, those which are the closest to the display characteristics associated with this area, so that image data of at least a portion of the quality layer, associated with the image data type corresponding to the determined display characteristics, which have not been transmitted earlier, are transmitted to said client terminal (1).

9. The facility according to any of claims 7 and 8, characterized in that, consecutively to receiving the first and second requests for accessing an image including first and second pieces of area information, said second processing means (16) are able to i) compare the first and second pieces of area information in order to determine at least a possible non-overlapping area, and ii) transmitting to the first processing means (1) image data associated with this nor-overlapping area, according to a resolution level corresponding to the display characteristics of its display means (5).

10. The facility according to any of claims 1 to 9, characterized in that the first processing means (21) of client terminal (1) are configured for placing in an access request, a piece of information referring to a resolution level and in that the second processing means (16) are configured for i) extracting the image data from different quality layers, associated with the required resolution level, ii) comparing the characteristics associated with this level to the display characteristics of the client terminal (1), iii) then for transmitting the data associated to this required resolution level when said associated characteristics are compatible with the display characteristics of the client terminal (1).

11. The facility according to any of claims 1 to 10, characterized in that the second processing means (16) are configured for transmitting with the image data, information referring to their resolution level and their quality layer, so that the first image means (21) rebuild the required image from data received as an answer to each of the access requests relative to this image.

12. The facility according to any of claims 1 to 11, characterized in that it comprises transformation means (17-20) configured for i) applying to the “raw” image data, contained in a primary file, a chromatic transformation for obtaining data transformed in a three-dimensional representation space including a luminance component (Y) and two chrominance components (U,V), as a row/column matrix, ii) applying to the transformed data, a wavelet breakdown technique in order to obtain different resolution levels, iii) applying to said resolution levels, a breakdown technique into complementary quality layers, iv) applying to said quality layers, a first function in order to obtain a breakdown into elementary encoding blocks, and v) storing said breakdown in a secondary file.

13. The facility according to claim 12, characterized in that the transformation means (17-20) are configured for i) breaking down the data transformed into a row/column matrix by applying to each resolution level a low pass filter (g) and a high pass filter (h) in order to obtain a first sub-band (H) including high frequency information on the columns, a second sub-band (V) including information on the rows, a third sub-band (D) including high frequency information along a main diagonal of the matrix and a fourth sub-band (T) including low pass type information, and ii) applying to said sub-bands of different resolution levels, a quantification step technique for generating said complementary quality layers.

14. The facility according to claim 13, characterized in that the quantification technique consists of:
a first step wherein an optimization function, depending on a certain number of bytes dedicated to a quality layer (Lᵢ) is applied to sub-bands, in order to determine a quantification step value (qᵢⱼ) for each sub-band, the set of said values forming a quantification bank (BQᵢ), then for each sub-band, the corresponding quantification step value (qᵢⱼ) is applied in order to obtain data associated with the quality layer (Lᵢ),
a second step wherein a dequantification bank (BQᵢ⁻¹) is determined, the inverse of quantification bank (BQᵢ), then this dequantification bank is fed with data associated to said quality layer (Lᵢ) and the quantification step values (qᵢⱼ) so as to determine an approximation for each sub-band which is then compared to the corresponding sub-band in order to obtain an error sub-band (E_{i+1,j}),
a third step wherein the first, second and third steps are repeated with another number of bytes dedicated to another quality layer (Lᵢ₊₁), in order to obtain data associated with this other layer (Lᵢ₊₁) and new error sub-bands, as long as the respective contents of error sub-bands (E_{i+1,j}) remain greater than selected thresholds, whereby the quantification terminates in the opposite case.

15. The facility according to claim 14, characterized in that the number of bytes dedicated to each quality layer (Lᵢ) is selected depending on the data throughput characteristics for the network to which the client server (1) is connected.

16. The facility according to any of claims 12 to 15, characterized in that the first function consists i) in breaking down the first (H), second (V) and third (D) sub-bands of each resolution level of each quality layer (Lᵢ) into elements associated with regions of the image, ii) then in concatenating the elements of each sub-band associated with identical regions in order to form elementary encoding blocks each including three elements, whereby one of the elements of each block has undergone a rotation and a mirror symmetry beforehand, iii) and finally in entropically encoding each elementary block.

17. The facility according to any of claims 12 to 16, characterized in that it comprises a data base able to store said files of the transformation means and connected to said server terminal.

18. The facility according to any of claims 12 to 17, characterized in that said transformation means (17-20) are implemented in said server terminal (2).

19. The facility according to any of claims 1 to 18, characterized in that, in the case of a network having data throughput characteristics preventing the server terminal (2) from sending in an unique answer, complementary image data associated with a resolution level of the quality layers, said second processing means (16) are configured for transmitting said image to the client terminal (1) in successive answers each including complementary data associated with layers of increasing quality, and in that said processing means (21) of client terminal (1) include image rebuilding means (22) configured, upon receiving successive answers, for gradually rebuilding the transmitted image until the highest image quality is achieved, determined by said second processing means (16).

20. The facility according to claim 19, characterized in that said rebuilding means (22) are configured for:
a) applying to a first received quality layer (Lᵢ) the dequantification bank (BQᵢ⁻¹) associated with this layer in order to rebuild these sub-bands (SBᵢ) which it contains and applying to these sub-bands an inverse transformation (W⁻¹) in order to rebuild the image data of this quality layer to be displayed,
b) applying to a second received quality layer (Lᵢ₊₁) the dequantification bank (BQᵢ₊₁⁻¹) associated with this layer for rebuilding the sub-band (SBᵢ) which it contains and merging them with the sub-bands of the previous layer(s) then applying to these merged sub-bands said inverse transformation (W⁻¹) in order to determine fresh image data to be displayed,
c) repeating step b) for each of the following quality layers by merging at each time the sub-bands which it contains with those of the previous layers.

21. A device for transmitting image data, characterized in that it includes second image processing means (16) according to any of the preceding claims.

22. The device for transmitting image data, according to claim 21, characterized in that it includes transformation means (17-20) according to any of claims 12 to 20.

23. The device for receiving image data, characterized in that it includes first image processing means (21) according to any of claims 1 to 20.

24. A method for exchanging image data between client terminals and at least a service terminal, via a communications network, of the type comprising a first step wherein a client terminal (1) transmits to the server terminal (2) a request for accessing an image, broken down into resolution levels and quality layers, and a second step wherein said server terminal (2) transmits to the client terminal (1) at least a portion of the broken down image data so that they are displayed after recomposition,
characterized in that in the first step, the access request includes display characteristics of the display means (5) of the client terminal (1), and in the second step i) the characteristics of the display means (5) are extracted from the access request, ii) a correspondence is established between at least a data type of the image and the display characteristics, and iii) from the display characteristics corresponding to different data types of the image, those which are the closest to the extracted display characteristics are determined according to a selected criterion, so that the image data associated with the image data type corresponding to the determined characteristics are transmitted to said client terminal.

25. The method according to claim 24, characterized in that in the second step, complementary data layers are generated.

26. The method according to claim 25, characterized in that in the second step, image data from at least a portion of the quality layers, associated with the image data type corresponding to the determined display characteristics are transmitted.

27. The method according to any of claims 24 to 26, characterized in that in the first step the display characteristics include at least a data display area format.

28. The method according to any of claims 24 to 27, characterized in that the display characteristics further include a certain number of encoding bits for the pixels of the display area.

29. The method according to any of claims 24 to 28, characterized in that in the second step, the determined image data and the resolution level for the data of this image are sent together.

30. The method according to any of claims 24 to 29, characterized in that in certain first steps, following a first series of first and second steps, a piece of information referring to an image area is placed in the access request so that the server terminal (2) transmits the image data associated with this area.

31. The method according to claim 30, characterized in that, as an answer to a first step including image area information, in a second step, i) said area information is extracted in order to determine the associated display characteristics, and ii) from the display characteristics corresponding to the image data types, those which are the closest to the display characteristics associated with the area, are determined so that the image data of at least portion of the quality layers, associated with the image data type corresponding to the determined display characteristics, which have not been transmitted earlier, are transmitted to said client terminal (1).

32. The method according to any of claims 30 and 31, characterized in that, consecutively to receiving the first and second requests for accessing an image including first and second pieces of area information, in a second step i) a comparison is made between the first and second pieces of area information in order to determine at least a possible non-overlapping area, and ii) the image data associated with this non-overlapping area are transmitted, according to a resolution level corresponding to the display characteristics of the client terminal (1).

33. A method according to any of claims 23 to 30, characterized in that, in the first step, a piece of information referring to a resolution level is placed in the access request, and in that in the second step, i) the image data of different quality layers associated with the required resolution level are extracted, ii) the characteristics associated with this level are compared with the display characteristics of the client terminal, iii) then the data associated with this required resolution level are transmitted when said associated characteristics are compatible with the display characteristics of the client terminal (1).

34. The method according to any of claims 24 to 33, characterized in that in the second step, along with image data, information referring to their resolution level and their quality layer is transmitted, so that the required image is rebuilt from the received data as an answer to each of the access requests relative to this image.

35. The method according to any of claims 24 to 34, characterized in that it comprises a data transformation step wherein i) a chromatic transformation for obtaining transformed data, as a row/column matrix, in a 3-dimensional representation space including a luminance component (Y) and two chrominance components (U,V) is applied to “raw” image data contained in a primary file, ii) a wavelet breakdown technique is applied to the transformed data is order to obtain different resolution levels, iii) a breakdown technique into complementary quality layers is applied to said resolution levels, iv) a first function is applied to said quality layers in order to obtain a breakdown into elementary encoding blocks, and v) said breakdown is stored in a secondary file.

36. The method according to claim 33, characterized in that in the transformation step i) the data transformed into a row/column matrix are broken down by applying on each resolution level a low pass filter (g) and a high pass filter (h) in order to obtain a first sub-band (H) including high frequency information on the columns, a second sub-band (V) including high frequency information on the rows, a third sub-band (D) including high frequency information along a main diagonal of the matrix and a fourth sub-band (T) including low pass type information, and ii) a step quantification technique for generating said complementary quality layers is applied to said sub-bands of different resolution levels.

37. The method according to claim 36, characterized in that in the transformation step, the quantification technique consists of:
a first phase wherein an optimization function, depending on a certain number of bytes dedicated to a quality layer (Lᵢ) is applied to the sub-bands, in order to determine a quantification step value (q_{i,j}) for each sub-band, the set of said values forming a quantification bank (BQᵢ), then, for each sub-band, the corresponding quantification step value (q_{i,j}) is applied in order to obtain the data associated with the quality layer (Lᵢ),
a second phase wherein a dequantification bank (LBQᵢ⁻¹), the inverse of the quantification bank (BQᵢ) is determined, then this dequantification bank is fed with data associated with said quality layer (Lᵢ) and the quantification step values (q_{i,j}) in order to determine an approximation for each sub-band which is then compared to the corresponding sub-band in order to obtain error sub-bands (E_{i+1,j}),
a third phase wherein the first, second and third phase are repeated with another number of bytes dedicated to another quality layer (Lᵢ₊₁) in order to obtain data associated with this other layer (Lᵢ₊₁) and new error sub-bands, as long as the respective contents of the error sub-bands (E_{i+1,j}) remain greater than selected thresholds, whereby the quantification terminates in the opposite case.

38. The method according to claim 37, characterized in that the number of bytes dedicated to each quality layer (Lᵢ) is selected according to the data throughput characteristics of the network to which the client terminal is connected.

39. The method according to any of claims 35 to 38, characterized in that the first function consists in i) breaking down the first (H) the second (V) and third (D) sub-bands of each resolution level of each quality layer (Lᵢ) into elements associated with regions of the image, ii) then concatenating elements of each sub-band associated with identical regions in order to form elementary encoding blocks each including three elements, whereby one of the elements of each block has undergone a rotation and a mirror symmetry beforehand, iii) and finally entropically encoding each elementary block.

40. The method according to claims 24 to 39, characterized in that in the first step said image data files are extracted from a data base.

41. The method according to any of claims 34 to 40, characterized in that the transformation step is carried out in said server terminal (2).

42. The method according to any of claims 24 to 41, characterized in that, in the case of a network having data throughput characteristics preventing the server terminal (2) from sending in a unique answer, complementary image data associated with a resolution level of the quality layers, in the second step i) said image data are transmitted to the client terminal (1) in the successive answers each including complementary data associated with layers of increasing quality, and ii) upon receiving the successive answers, the transmitted image is gradually rebuilt until the highest image quality is obtained.

43. The method according to claim 42, characterized in that the rebuilding consists of:
a) applying to a first received quality layer (Lᵢ) the dequantification bank (BQᵢ₋₁) associated with this layer in order to rebuild the sub-band (SBᵢ) which it contains and applying to the sub-band an inverse transformation (W₋₁) in order to rebuild the image data of this quality layer to be displayed,
b) applying to a second received quality layer (Lᵢ₊₁) the dequantification bank (BQᵢ₊₁⁻¹) associated with this layer in order to rebuild the sub-bands (SBᵢ) which it contains and merging them with the sub-bands of the previous layer(s) then applying to these merged sub-bands said inverse transformation (W⁻¹) in order to determine fresh image data to be displayed,
c) repeating step b) for each of the following quality layer by merging every time the sub-bands which it contains, with those of the previous layers.

44. The use of the method, of the facility of the transmitting device and of the receiving device according to any of the preceding claims, in communications networks selected from public networks and private networks.
